(19) United States
(12) Patent Application Publication
(10) Pub. No.: US 2016/0138696 A1
(43) Pub. Date: May 19, 2016

(54) GEARWHEEL ARRANGEMENT

(71) Applicant: MIBA SINTER AUSTRIA GMBH, Laakirchen (AT)

(72) Inventors: Franz-Josef GIELESBERGER, Ohlsdorf (AT); Alexander MUELLER, Altmuenster (AT)

(73) Assignee: MIBA SINTER AUSTRIA GMBH, Laakirchen (AT)

(21) Appl. No.: 14/926,631

(22) Filed: Oct. 29, 2015

(30) Foreign Application Priority Data
Nov. 19, 2014 (AT) A 50841/2014

(51) Int. Cl. F16H 55/14; F16F 15/121; F16H 55/17

(52) U.S. Cl. CPC F16H 55/14; F16H 55/17; F16F 15/1215

(57) ABSTRACT

The invention relates to a gearwheel arrangement (1) comprising a first component (3) and a second component (4), wherein the first component (3) comprises a toothing (6), the second component (4) is arranged at least partly inside the first component (3), and wherein between the first component (3) and the second component (4) at least one elastically deformable element (5) is arranged which on elastic deformation in circumferential direction (19) opposes a different resistance than in radial direction.

The invention relates to a gearwheel arrangement comprising a first component and a second component, wherein the first component comprises a toothing and first projections projecting below the toothing in axial direction, between which projections gaps are formed, the second component is arranged at least partly inside the first component and comprises second projections projecting in axial direction, which engage in the gaps between the first projections of the first component, and wherein between the first component and the second component at least one elastically deformable element is arranged.

To avoid creating vibrations during the transfer of torque by means of gearwheels it is known from the prior art to use elastically deformable elements. Thus for example, AT 501 915 A4 describes a device for the rotary elastic transfer of torque between a shaft and a gearwheel mounted on a shaft and forming a gear rim and a hub with two coupling parts assigned in a rotationally secure manner on the one hand to the shaft and on the other hand to the gear rim, which coupling parts have claws projecting against one another and with offset gaps, and elastomer damping bodies arranged between the claws, wherein the two coupling parts are supported by the damping bodies solely in circumferential direction and the gear rim is mounted over the hub in radial direction rigidly relative to the shaft. As the gap between the claws of the two coupling parts is filled with an elastomer material, rotary vibrations occurring between the gear rim and the hub are damped by the elastomer intermediate layer between the opposite flanks of the interlocking claws. By means of the rigid bearing of the gear rim in radial direction if necessary additional vibrations which may occur are avoided which can have a disadvantageous effect on the tooth engagement.

The principle of the elastic transmission of torque is also applied in the area of balance shafts in drives. For example DE 10 2011 018 771 A1 describes a vehicle device for a combustion engine comprising at least one crankshaft, at least one first gearwheel which is connected to the crankshaft in a rotationally secure manner by at least one balance shaft, which is provided to reduce at least rotary vibrations of the combustion engine, at least one second gearwheel which is connected in a rotationally secure manner to the balance shaft and is in operative connection with the first gearwheel and at least one decoupling element which is provided to uncouple the first gearwheel from the at least one crankshaft and/or the second gearwheel from the at least one balance shaft.

It is also known that in such gearwheel arrangements the elastomer element not only acts in circumferential direction but also in radial direction. Thus for example, DE 101 16 236 A1 describes a gearwheel comprising an inner part and an annular outer part provided with peripheral teeth, wherein the outer part surrounds the inner part peripherally at a radial distance and wherein in the gap formed by the spacing at least one spring body made from an elastomer material is arranged. The spring body can be designed to be essentially wave-like, closed in circumferential direction, wherein the inner part comprises first projections pointing radially outwards and distributed evenly in circumferential direction, the outer part comprises second projections pointing radially inward and distributed evenly in circumferential direction, and the number of first projections corresponds to the number of second projections and the first and second projections overlap one another in radial direction. For the transfer of force facing peripheral flanks of the projections of inner part and outer part are supported in circumferential direction by means of the elastomer material of the spring body arranged in between, so that the elastomer material in this area is only exposed to pressure pretensioning. It is thus possible that the spring body may get damaged and/or destroyed by an undesirably high shearing tension, if the forces to be transmitted are too high. The gearwheel thus has dry-running properties, as even in the case of a damaged and/or destroyed spring body the transfer of force between the inner part and the outer part is not interrupted, as by means of the overlap of the projections in radial direction the projections are supported on one another and the transfer of force is thus ensured.

The objective of the invention is to improve the aforementioned gearwheel arrangement with regard to the transfer of torque.

Said objective of the invention is achieved in the aforementioned gearwheel arrangement in that the at least one elastically deformable element with an elastic deformation in circumferential direction opposes a different resistance than in radial direction.

It is an advantage that—as already known—oscillations can be absorbed by the at least one elastic element during the transfer of torque, but not only in circumferential direction, damping can also occur in radial direction, wherein the damping in radial direction is configured differently so that the gearwheel arrangement can be adapted easily to different applications with regard to their damping properties. By means of the different rigidity of the at least one elastic element in radial direction and in circumferential direction of the gearwheel arrangement, despite the option of vibration damping in both directions of the gearwheel arrangement a greater degree of security can be achieved to prevent the at least one elastic element falling out due to overloading. The gearwheel arrangement can thus absorb pulses which can cause vibrations more effectively in the direction from which they are normally expected in a specific application. By means of the damping in the second direction said pulses can also be absorbed more effectively, however the at least one elastic element can have a greater strength, whereby the stability of the gearwheel arrangement in this direction can be improved and thus greater forces can be absorbed.

According to one embodiment variant of the gearwheel arrangement it is possible for the elastically deformable element on elastic deformation in circumferential direction and clockwise opposes a different resistance than on elastic deformation in circumferential direction and counter-clockwise. In other words the elastic element on deformation in rotational direction opposes a different resistance than in the rotational direction. It is an advantage here that in this way the elastically deformable element can be adapted more effectively to the anticipated mechanical stresses, so that on the one hand the latter can have a greater mechanical load bearing ability in rotational direction and at the same time in this way also an elastic element can be provided with suitable damping properties.

It is also possible that the first component underneath the toothing in axial direction comprises projecting first projections, between which gaps are formed and that also the second component comprises second projections projecting in axial direction, which engage in the gaps between the first projections of the first component and that the at least one elastically deformable element engages at least partly between the first projections of the first component and the second projections of the second component and in the area of engagement comprises first exemptions. By means of said first exemptions the varying rigidity of the at least one elastic element in radial and circumferential direction can be achieved simply in that the material of the at least one elastic element can move aside under stress into said first exemptions. It is thus possible that the at least one elastic element can remain unchanged with regard to its composition, i.e. with respect to the material used, in order to obtain the desired rigidity. In addition, it is an advantage that by means of the size of the recesses, also the extent of the rigidity in both directions can be adapted easily to different applications.

According to one embodiment variant it is possible that the first exemptions are designed in the form of breakthroughs. It is thus possible to reduce the area extension of the first exemptions or with the same area extension to increase the difference in rigidity behavior of the at least one elastic element in both directions.

The first exemptions can be formed or arranged alternatively or in addition in the first component and/or in the second component in the region of the bearing of the at least one elastically deformable element. It is thus also possible to ensure that the at least one elastic element can deflect into said first exemptions under corresponding mechanical stress during the transfer of torque, and thus the at least one elastic element in both directions of deformation opposes a different resistance.

In the preferred embodiment variant the at least one elastically deformable element is designed as an elastomer ring with deforming elements. The latter can be produced simply with regard to different rigidities and also the assembly of the gearwheel arrangement can be designed more simply. In addition, the elastomer ring does not necessarily require changes to the first and second component of the gearwheel arrangement in order to achieve the functionality of different rigidities of the at least one elastomer element.

In this case the elastomer ring is made preferably of a single elastomer. In this way it is possible to achieve a further simplification of the production of the gearwheel arrangement. The varying rigidity of the elastomer ring in both given directions can be preferably achieved by geometric configuration. Thus it is possible not to use inserts or mix the elastomer with less elastic elements, etc. whereby the at least one elastic element of the gearwheel arrangement can be produced less expensively. In particular, in this case it is not necessary to take into consideration material compatibilities, and the premature ageing of the at least one elastomer element can be avoided which may be caused by having an additional material in the latter. Likewise, bonding problems, e.g. of an elastomer filled with an additional material for reinforcement, are not relevant. The at least one elastomer element can thus be configured to be more operationally reliable.

According to another embodiment variant of the gearwheel arrangement it is possible to provide a plurality of elastically deformable elements which are in the form of platelet-like springs, the springs being oriented in radial direction. Compared to the elastomer ring the assembly of the gearwheel arrangement is more complex, however, this embodiment variant has the advantage that if one of the elastically deformable elements gets damaged the others can still continue to fulfil their function. In this way also a greater degree of operating safety can be achieved with suitable dry-running properties. Furthermore, if a spring breaks only the damaged spring has to be replaced and not the whole system of the vibration damping itself.

According to a further embodiment variant it is possible that the springs engage in mounts in the first component and in mounts in the second component. It is thus possible to achieve a simple connection of the elastically deformable elements into the gearwheel arrangement, and in addition the assembly of the gearwheel arrangement can be simplified in that the elastically deformable elements only have to be pushed into the mounts in axial direction.

Preferably, the resistance, that the at least one elastically deformable element opposes on elastic deformation in circumferential direction, is smaller than the resistance, that the at least one elastically deformable element opposes on elastic deformation in radial direction. In this way vibrations can be damped which are caused by a shaft on which the gearwheel arrangement is arranged, or by an additional gearwheel meshing with the gearwheel, on the other hand in this way the meshing engagement with the additional gearwheel can be improved with respect to its precision, in that the toothing of the gearwheel arrangement relative to the toothing of the additional gearwheel is or remains true to its path.

It is also preferable if the second component is guided with an end surface on the first component. In this way a mechanical failure protection is provided in case of the failure of the at least one elastically deformable element, so that further damage to additional components, e.g. to a drive train of a motor vehicle, can be averted or prevented.

For a better understanding of the invention the latter is explained in more detail with reference to the following Figures.

In a simplified schematic representation:

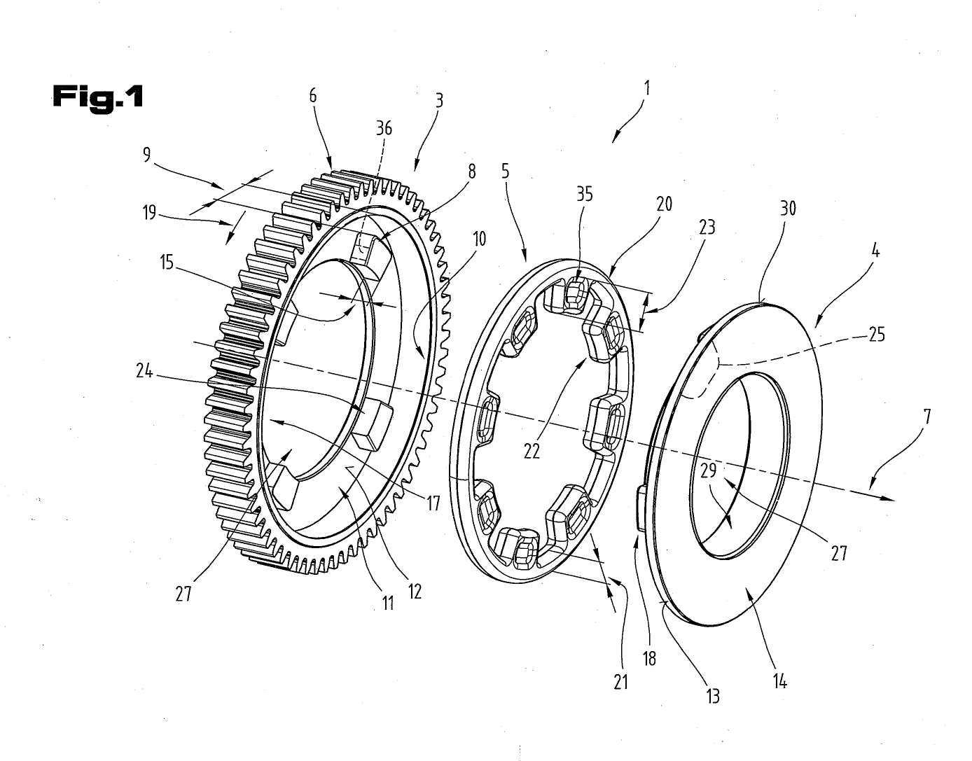

FIG. 1 shows a first embodiment variant of a gearwheel arrangement in oblique view in an exploded representation;

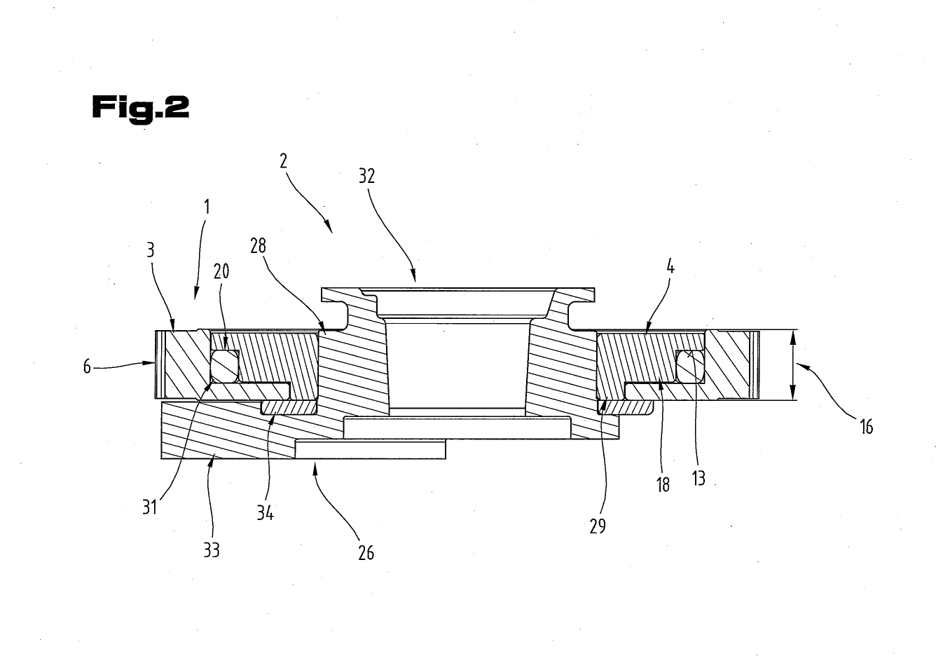

FIG. 2 shows the use of a gearwheel arrangement for mass balancing in a cross-sectional view;

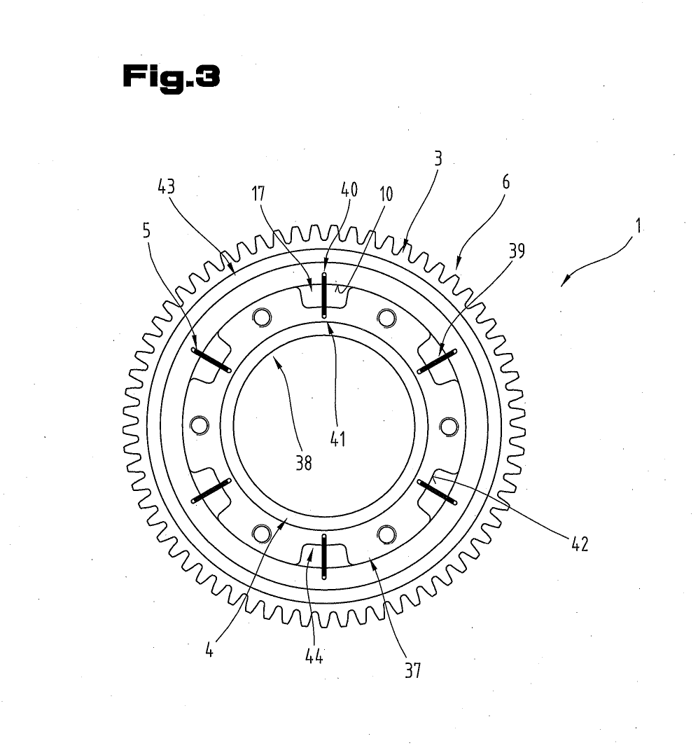

FIG. 3 shows a second embodiment variant of the gearwheel arrangement in axial view;

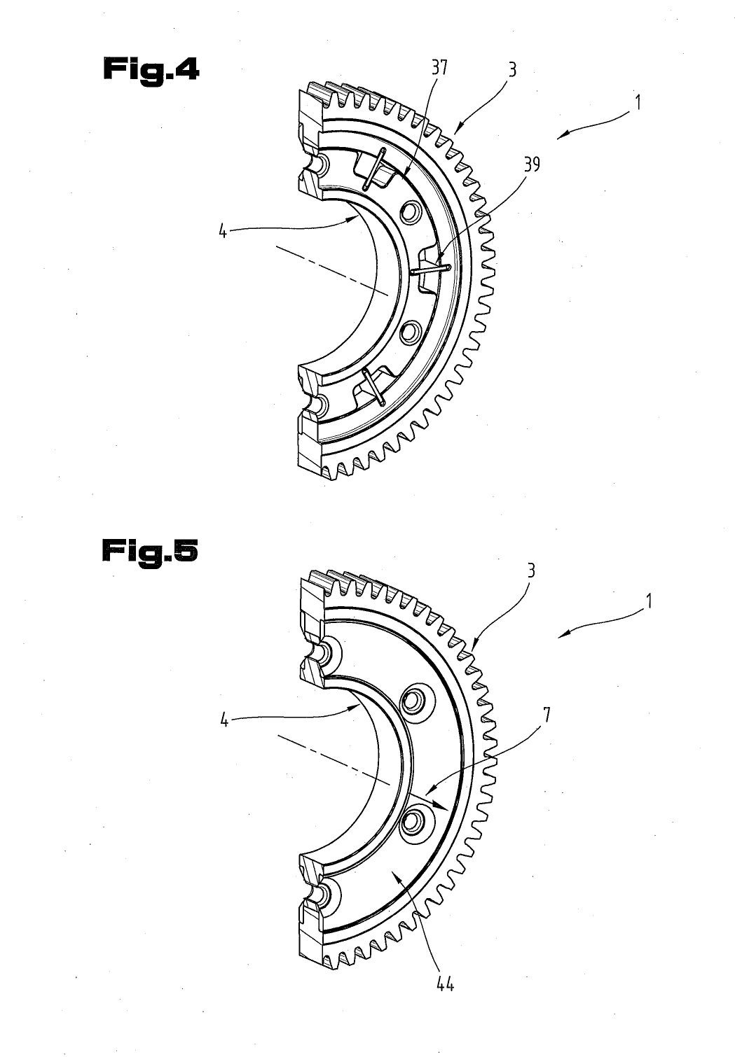

FIG. 4 shows a cross section of the gearwheel arrangement according to FIG. 3 in an oblique view;

FIG. 5 shows the representation of the gearwheel arrangement according to FIG. 4 with attached covers.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position.

In FIGS. 1 and 2 a first embodiment variant of a gearwheel arrangement 1 and its use is shown in a mass balance 2 for a drive train of a motor vehicle.

The gearwheel arrangement 1 comprises a first, radially outer component 3, a second, radially inner component 4 arranged concentric thereto and an elastically deformable element 5 or consists of said elements. The first, radially outer component 3 comprises on an end side a toothing 6 in the form of a spur gearing.

Said toothing 6 can have a form adapted to the respective application of the gearwheel arrangement 1, for example for the formation of a transmission gearwheel. However, other forms of toothing 6 are also possible, for example an oblique toothing etc. Furthermore, the toothing 6 can extend in an axial direction 7 of the gearwheel arrangement 1 over the whole width of the first, outer component 3 or only over a portion of said width.

The second component 4 is arranged at least partly inside the first component 3. The at least one elastically deformable element 5 is arranged between the first component 3 and the second component 4.

It should be noted that the terms “radially outer” and “radially inner” do not necessarily mean that the first component 3 is arranged relative to the second component 4 fully radially above the latter and that the second component 4 is arranged relative to the first component 3 fully radially below the latter, as shown from FIGS. 1 and 2. Rather it is possible to have an “overlapping area”.

The second, radially inner component 4 can also be denoted as a hub part and the first, radially outer component 3 can be denoted as a gear rim.

The first, radially outer component 3 comprises first projections 8 (cams) projecting underneath the toothing 6 in axial direction 7, which are designed in particular in one piece with the first, radially outer component 4. In the shown embodiment variant of the gearwheel arrangement 1 four such first projections 8 are arranged or formed. However, it should be noted that this number of first projections should not be considered restrictive. Also fewer or more such first projections 8 can be arranged or formed on the first, radially outer component 3.

The first projections 8 are arranged or formed with the formation of a distance 9 from a lower side 10 of the toothing 6. For this the first, radially outer component 3 comprises an annular end wall 11, which is connected to the toothing 6 and extends radially inward. The first projections 8 are formed on said annular end wall 11. The first projections 8 extend from an inner surface 12 of the annular end wall 11 in the direction of an inner surface 13 of an also annular end wall 14 of the second, radially inner component 4. The first projections 8 comprise, as viewed in the direction of the axial direction 7, an approximately trapezoidal cross section or are in the form of circular ring segment, but can also have a different cross section. The first projections 8 preferably have a height 15 over the surface 12 of the annular end wall 11, i.e. in axial direction 7, which corresponds at most to a width 16 of the gearwheel arrangement 1 in axial direction 7 minus the thickness of the end wall 11 of the first, radially outer component 3 and minus the width of the end wall 14 of the second, radially inner component 4.

Gaps 17 are formed between the first projections 8 of the first, radially outer component 3.

The second, radially inner component 4 is arranged at least partly, in particular fully, inside the first, radially outer component 3. On the inner surface 13 of its annular end wall 14 the first, radially inner component 4 comprises second projections 18 (cams). The second projections 18 extend from the inner surface 13 of the annular end wall 14 in axial direction 7 in the direction of the inner surface 12 of the annular end wall 11 of the first, radially outer component 3. Furthermore, the second projections 18 of the second, radially inner component 4 are arranged in the gaps 17 between the first projections 8 of the first, radially outer component 3.

Preferably, the second projections 18 are arranged at least approximately, in particular precisely, at the same radial height as the first projections 8.

The size and form of the second projections 18 preferably correspond to those of the first projections 8. The second projections 18 can however also have a shape and/or size that is different from the size and form of the first projections 8.

In the shown embodiment variant four second projections 18 are arranged on the second, radially inner component 4. The number of second projections 18 can also differ however. Also more or fewer second projections 18 can be provided. In the preferred embodiment variant of the gearwheel arrangement 1 however the number of first projections 8 equals the number of second projections 18, so that in each gap 17 between the first projections 8 a second projection 18 is arranged.

The gaps 17 between the first projections 8 are larger in circumferential direction 19 than the extension of the second projections 18 in circumferential direction 19, so that the second projections 18 are arranged at least on one side, preferably on both sides (relative to the circumferential direction 19) forming distances spaced apart from the first projections 8. At these intervals the at least one elastically deformable element 5 is arranged, wherein between each first projection 8 and each projection 18 at least a part of the elastically deformable element 5 is arranged.

The at least one elastically deformable element 5 is preferably designed to be annular as an elastomer ring, as shown in FIG. 1. For this the elastically deformable element 4 has in particular a closed, annular main body 20. A width 21 of the main body 20 in radial direction is dimensioned so that it is not greater than the distance 9 between the lower side 10 of the toothing 6 of the first, radially outer component 3 and the upper side of the first projection 8 pointing to this lower side 10. In this way the annular main body 20 can be arranged between the toothing 6 and the first projections 8, as shown in FIG. 2. As the second projections 18 of the second, radially inner component 4 are arranged at least approximately, in particularly exactly, at the same radial height as the first projections 8, the main body 20 can also be arranged in radial direction above the second projections 18. Preferably, the main body 20 of the elastically deformable element 5 bears on the lower side 10, the first projections 8 and the second projections 18, as also shown in FIG. 2.

The main body 20 can have an at least approximately square, an at least approximately rectangular, an at least approximately round or an at least approximately oval cross section. Other cross-sectional forms are also possible.

On the main body 20 a plurality of deforming elements 22 are arranged projecting radially inwardly over the latter. In the embodiment variant of the gearwheel arrangement 1 shown in FIG. 1 eight such deforming elements 22 are arranged, in particular are designed in one piece with the main body 20.

Said deforming elements 22 project into the distances between the first projections 8 and the second projections 18, so that the first projections 8 are separated by the deforming elements 22 from the second projections 18 in circumferential direction 19. Since eight such deforming elements 22 are provided, the latter bear as viewed in circumferential direction 19 on both sides of the first projections 8 and the second projections 18.

The deforming elements 22 have a height 23 in radial direction, which is dimensioned so that the deforming elements end at the height of radially lower sides 24, 25 of the first projections 8 or the second projections 18.

It is also possible, although not preferred, that the deforming elements 22 end in radial direction above the lower sides 24, 25 of the first or second projections 8, 18.

Furthermore, it is also possible, but not preferred, that only four such deforming elements 22 are provided and thus the first projections 8 bear with an end face pointing in circumferential direction 19 on the corresponding opposite end face of the second projections 18.

Generally it is preferred however, if the number of deforming elements 22 is twice as large as the number of first projections 8 or second projections 18.

According to another embodiment variant it is possible that the deforming elements 22 are inserted loosely between the first projections 8 and the second projections 18, i.e. are not formed on the main body 20 and generally no main body 20 is provided.

The first, radially outer component 3 and/or the second, radially inner component 4 preferably consist of a metal material, for example steel, preferably a sintered material, for example a sintered steel. However, also other metal materials can be used for the first, radially outer component 3 and/or the second, radially inner component 4, wherein the first, radially outer component 3 and/or the second, radially inner component 4 can consist of at least two different metal materials.

The at least one elastic deformable element 5 consists at least partly, in particularly fully, of at least one rubber-elastic material, for example an (X)NBR ((carboxylated) acrylonitrile-butadiene-rubber), HNBR (hydrated nitrile-rubber), a silicon-rubber (VMQ), NR (natural rubber), EPDM (ethylene-propylene-diene-rubber), CR (chloroprene rubber), SBR (styrene-butadiene rubber) etc., wherein here mixtures of material can also be used.

The term “at least partly” means that for example reinforcing elements, such as e.g. fibers and/or threads, for example made of metal, plastic, natural fibers etc. or rods etc., can be embedded into the at least one elastically deformable element 5. Preferably, the at least one elastically deformable element 5 is made solely from a rubber-elastic material. Particularly preferably however, the at least one elastically deformable element 5 is made from a single elastomer.

By means of the at least one elastically deformable element 5 oscillations which are transmitted from the second component 4 to the first component 3 or from the first component 3 to the second component 4 can be damped. In particular, in this way occasional peak pulses from the second component 4 to the first component 3 or from the first component 3 to the second component 4 can be absorbed.

As shown in the application illustrated in FIG. 2 the gearwheel arrangement 1 can be arranged on an imbalance element 26. For this the end walls 11, 14 of the first component 3 and the second component 4 have a recess 27 running in axial direction, in particular a bore. The recess 27 of the second, radially inner component 4 has a smaller diameter, i.e. the recess 27 of the first, radially outer component 3. Thus the gearwheel arrangement 1 sits over the second, radially inner component 4 on a hub part 28 of the imbalance elements 26 and is connected via the latter to the imbalance element 26. For this the second, radially inner component 4 comprises an annular web 29 projecting in axial direction 7 from the annular end wall 14. Said annular web 29 also projects through the recess 27 of the first, radially outer component 3, wherein the latter bears with the annular end wall 11 on the annular web 29.

It should also be mentioned that the second projections 18 of the second, radially inner component 4 are preferably formed on the annular web 29.

It should also be mentioned that the gearwheel arrangement can also be arranged on a shaft without an imbalance element 26 over the recess 27.

As the second projections 18 of the second, radially inner component 4 end in radial direction below a radial end face 30 of the annular end wall 14, and the second component 4 with the radial end face 30 preferably fits against the first component 3 on the lower side 10 of the toothing 6, between the latter a cavity 31 is formed for mounting the main body 20 of the elastomer ring.

The imbalance element 26 can in turn comprise a recess 32, in particular a bore, for arranging on a shaft.

Such unbalancing elements are used in particular in the balance shafts of combustion engines.

To form the imbalance the imbalance element 26 comprises an uneven distribution of mass, which is achieved by the formation of an imbalance mass 33, wherein said imbalance masse 33 is only arranged or formed over a portion of the circumference of the imbalance element 26.

The gearwheel arrangement 1 is preferably arranged with the intermediate arrangement of a ring element 34 on the unbalancing element 26, wherein the ring element 34 bears on the imbalance mass 33 on the one hand and on the gearwheel arrangement 1 on the other hand.

The at least one elastically deformable element 5 opposes on elastic deformation in circumferential direction 19 a different resistance than in radial direction. In other words, the at least one elastic element 5 has a different rigidity in circumferential direction than in radial direction. Here at least one elastic element 5 has a directionally dependent rigidity.

In the embodiment of the at least one elastic element 5 as a deforming element 22 or as an elastomer ring with deforming elements 22, this can be achieved for example by using varyingly rigid elastomers for producing the deforming elements 22 or the elastomer ring with the deforming elements 22. Alternatively or in addition, also reinforcing elements, such as e.g. fibers or platelets or spring platelets, can be incorporated in a preferred orientation into the at least one elastomer.

However, as this is fairly complex for the production of the at least one elastic element 5, the latter is preferably made from only a single elastomer and thus consists of only a single elastomer. In this case, the at least one elastic element 5 comprises first exemptions 35. In this way the elastomer when under mechanical stress can deflect into said first exemptions 35 more easily than in areas without first exemptions 35.

In the embodiment variant of the gearwheel arrangement 1 according to FIG. 1 said first exemptions are designed as depressions in the deforming elements 22. Specifically, said depressions essentially have the cross sectional form—as viewed in axial direction 7—of the deforming elements 22, but are designed to have a smaller area so that they are surrounded by a raised edge.

This form should not be considered to be restrictive however. Rather said depressions can also have different cross sectional forms—as viewed in axial direction 7. For example, they can be round, oval, rectangular, square, triangular, or generally polygonal, etc.

However it is also possible to reverse this so that no depressions are arranged or formed on the deforming elements 22, but raised areas. Likewise, both raised and also depressed areas can be arranged or formed. Furthermore, also more than one or these depressed and/or raised areas can be provided per deforming elements 22. Furthermore, said depressed and/or raised areas are preferably arranged or formed on both sides—as viewed in axial direction 7—on the deforming elements 22, wherein according to a further embodiment variant said raised and/or depressed areas can have a different form on both sides. It is also possible that a plurality of depressed and/or raised areas are formed or arranged on one side of the deforming elements 22 with a different form. The precise placing of said first exemptions 35 or raised areas can be selected according to the respective use of the gearwheel arrangement 1 or adapted thereto.

In addition or alternatively to this it is possible that (also) the main body 20 of the elastomer ring is provided with such first exemptions 25 and/or raised areas.

The first exemptions 35 are preferably already considered and formed on the production of the deforming elements 22 or the elastomer ring with the deforming elements or generally the at least one elastic element 5. However, it is also possible to produce the latter subsequently, for example by means of machining methods, e.g. milling.

According to a further embodiment variant of said first exemptions 35 the latter can also be designed as breakthroughs through the deforming elements 22 and/or the main body 20 of the elastomer ring with the deforming elements 22 or generally by the at least one elastic element 5. Said breakthroughs are preferably formed in axial direction 7. It is also preferred, if the breakthroughs have a shape which has a larger extension in radial direction than in circumferential direction 19, for example are designed as ovals oriented in radial direction.

Alternatively or in addition to the first exemptions 35 or raised areas in the at least one elastic element 5 according to another embodiment variant of the gearwheel arrangement 1 it is possible to provide or form second exemptions 36 in the first projections 8 of the first component 3, as shown by a dashed line in FIG. 1 by way of a first projection 8. However, it should be noted that all of the first projections 8 comprise such second exemptions 36.

Preferably, said second exemptions 36 are formed in the bearing surfaces of the at least one elastic element 5 on the first projections 8, whereby it is also preferred if said second exemptions 36 as viewed in circumferential direction 19 are arranged or formed on both bearing surfaces for the at least one elastic element 5.

With respect to the form, number and production of said second exemptions 36 reference is made to the preceding explanations about the first exemptions 35 in the at least one elastic element 5.

Alternatively or in addition it is possible that also the second projections 18 of the second component 4 have such second exemptions 36, even though this is not represented in FIG. 1.

The at least one elastic element 5 made from the elastomer can be connected to the first and/or second component 3, 4, for example by adhesion. It is also possible that the latter is vulcanized or the connected is formed solely by adhesive friction. The connection can be formed for example to the lower side 10 of the toothing 6 and/or to the first and/or second projections 3, 4.

To improve the formation of the connection it is also possible to roughen the surfaces to be connected, for example by (sand) blasting or by grinding, etc.

Preferably, all of the edges of the elastomer ring with the deforming elements 22 or the deforming elements 22 are provided with roundings.

According to a further embodiment variant of the gearwheel arrangement 1 it is possible that the elastically deformable element 5 on elastic deformation in circumferential direction 19 and clockwise opposes a different resistance than on elastic deformation in circumferential direction 19 and counter-clockwise. In particular, the elastic element 5 in rotary direction of the gearwheel arrangement 1 has, for example clockwise, a greater rigidity than in the opposite direction, for example counter-clockwise. This can be achieved for example in that the first exemptions 35 have a suitable geometry, for example a cross section decreasing in the direction of greater rigidity. Likewise, the greater rigidity in positive circumferential direction 19 than in negative circumferential direction 19 (relative to the clockwise direction) can be achieved by the suitable arrangement of the aforementioned reinforcing elements.

It is also possible that the resistance that the elastic element opposes on deformation which is different, in particular higher, in positive circumferential direction 19 than in the negative circumferential direction 19, is obtained by a suitable geometry of the second exemptions 36 in the projection 8 or the projections 8 of the radially outer component 3. For example, the second exemptions 36 which bear in circumferential direction 19 clockwise on the elastic element 5 can have a smaller volume that the second exemptions 36 which bear in circumferential direction 19 and counter-clockwise on the elastic element 5. Thus there is less volume available in circumferential direction 19 and clockwise for the deflection of the elastic element 5 under stress than in the opposite direction.

Furthermore, it is possible that in circumferential direction 19 only every second projection 8 is designed with a second exemption 36, so that the elastic element 5 bears for example under stress in circumferential direction 19 on a projection 8 with at least one second exemption 36 and under stress against the circumferential direction on a projection 8 without such a second exemption 36.

Furthermore, to achieve this effect it is possible that the first exemption 35 in the elastic element 5 is formed acentrally in the projections 8.

To achieve this effect it is also possible that at the radial level of the projections 8 intermediate elements are arranged between the deforming elements 22 of the elastic element 5. The latter can also be connected to the projections 8 or the deforming elements 22 or generally to the elastic element 5. To achieve the varying rigidity clockwise and counter-clockwise said intermediate elements can be made from materials of different hardnesses alternating in circumferential direction 19 and/or said intermediate elements can be designed alternating in circumferential direction 19 with a first width and a smaller width relative thereto.

Furthermore, to achieve this effect that the elastic element 5 on deformation opposes a different resistance clockwise and counter-clockwise in circumferential direction 19, it is possible that that the elastic element 5 comprises in circumferential direction 19 alternately arranged elastic deforming elements 22, which are provided with at least one first first exemption 35, and elastic deforming elements 22, which are provided with no first exemption or a first exemption 35 smaller than the first exemption 35.

FIG. 3 to 5 show a further and possibly independent embodiment of the gearwheel arrangement 1, wherein for the same parts the same reference numerals and component names are used as in the preceding FIGS. 1 and 2. To avoid unnecessary repetition reference is made to the detailed description of FIGS. 1 and 2.

The gearwheel arrangement 1 according to FIG. 3 to 5 also comprises the first component 3 and the second component 4, the second component 4 being arranged in radial direction below the first component 3.

The first component 3 comprises the toothing 6 on the outer circumference.

Unlike the previously described first embodiment variant the two components 3, 4 do not have projections 8, 18 projecting in axial direction 7 and in addition the first component 3 does not have any such projections at all.

The second component 4 comprises a plurality of projections 37 projecting in radial direction. In the specific embodiment six projections 37 are provided, whereby said number should not be considered to be restrictive. The projections 37 are arranged on the outer periphery of an annular main body 38 or formed in one piece with the latter. Like the aforementioned first and second projections 8, 18 the projections 37 are also designed to be in the form of circular segments and the gaps 17 are formed between the projections 37. In said gaps 17 a spring 39 is arranged respectively. However, also more than one spring 39 can be provided per gap 17.

The gearwheel arrangement 1 thus comprises a plurality of elastically deformable elements 5.

The springs 39 are preferably designed as small plates, wherein their longer narrow side, as shown in FIGS. 3 and 4, is preferably oriented in radial direction, so that the springs 39 are arranged to be standing. In other words the narrow sides are directed in axial direction.

It should be noted that the gearwheel arrangement 1 can also comprise a mixture of the two embodiment variants, thus both at least one of the elastomer elastically deformable elements 5 and also springs 39.

It is possible that the springs 39 are connected to the two components 3, 4, for example welded. In the preferred embodiment variant the springs 39 are arranged on the one hand in, in particular slot-like, mounts 40 in the lower side 10 of the toothing 6 of the first, radially outer component 3, and on the other hand in, in particular slot-like, recesses 41 on a radially outer upper side 42 of the main body 38 of the second, radially inner component 3 with its ends, wherein the middle part of the springs 37 preferably remains freely deformably in the gaps 17. Said embodiment variant has the advantage that the springs 39 simply have to be inserted into the corresponding mounts 40, 41 for connecting to the two components 3, 4. In addition, however also in this embodiment variant there can be a connection between the springs 39 and the mount 40, 41, for example by adhering to the mounts 40, 41.

Preferably, a mount 40 and a mount 41 are arranged opposite one another in radial direction respectively.

With this embodiment variant of the gearwheel arrangement it is also achieved that the elastically deformable elements on deformation oppose a directionally dependent resistance.

In general, in all of the embodiment variants of the gearwheel arrangement it is preferable if the resistance, that the at least one elastically deformable element 5 on an elastic deformation opposes in circumferential direction, is smaller than the resistance, that the at least one elastically deformable element on elastic deformation opposes in radial direction, i.e. the at least one elastic element is more rigid in radial direction than in circumferential direction. Thus, on the one hand the aforementioned damping effect is achieved, and on the other hand the running precision of the gearwheel arrangement 1 can be improved despite the provided elastically deformable elements 5.

The first, radially outer component 3 can also comprise on at least one, in particular both end face(s)—as viewed in axial direction 7—a shoulder 43 for mounting a ring element 44.

It is also preferred in all embodiment variants if the second component 4 is guided with an end surface on the first component 3. This is achieved in the first embodiment variant of the gearwheel arrangement 1 according to FIG. 1 by the end face 30 of the annular end wall 14, which bears on the first, radially outer component 3, and in the embodiment variant of the gearwheel arrangement 1 according to FIG. 3 to 5 by arranging the projections 37 on the lower side 10 of the toothing 6 of the first, radially outer component 3.

The gearwheel arrangement 1 has the advantage of mechanical securing, in case the at least one elastically deformable element 5 fails as a result of breaking.

It is possible to provide at least one fixed stop in the gearwheel arrangement 1 or a plurality of fixed stops, although this is not absolutely necessary. By means of said fixed stop or said fixed stops, if there is a tear in the elastic element 5, the relative rotatability of the radially inner component 4 is limited relative to the radially outer component 5, whereby the gearwheel arrangement 1 has an additional failure safety in case of at least partial damage to the elastic element 5. The gearwheel arrangement 1 can have a suitable failure safety both in radial and in circumferential direction 19.

Although above the use of the gearwheel arrangement 1 has been described in a mass balance, this should not be considered to be restrictive, although this is the preferred application of the gearwheel arrangement 1. The gearwheel arrangement 1 can thus also be used in other components, for example in a camshaft drive, a timing drive, a high pressure pump etc.

The embodiments show possible embodiment variants of the gearwheel arrangement 1, whereby it should be noted at this point that also various different combinations of the individual embodiment variants are possible.

Finally, as a point of formality, it should be noted that for a better understanding of the structure of the gearwheel arrangement 1, the latter and its components have not been represented true to scale in part and/or have been enlarged and/or reduced in size.

List of reference numerals

| | |
|---|---|
| 1 | gearwheel arrangement |
| 2 | mass balance |
| 3 | component |
| 4 | component |
| 5 | element |
| 6 | toothing |
| 7 | direction |
| 8 | projection |
| 9 | distance |
| 10 | lower side |
| 11 | end wall |
| 12 | surface |
| 13 | surface |
| 14 | end wall |
| 15 | height |
| 16 | width |
| 17 | gap |
| 18 | projection |
| 19 | circumferential direction |
| 20 | main body |
| 21 | width |
| 22 | deforming element |
| 23 | height |
| 24 | lower side |
| 25 | lower side |
| 26 | imbalance element |
| 27 | recess |
| 28 | hub part |
| 29 | annular web |
| 30 | end face |
| 31 | cavity |
| 32 | recess |
| 33 | imbalance mass |
| 34 | ring element |
| 35 | exemption |
| 36 | exemption |
| 37 | projection |
| 38 | main body |
| 39 | spring |
| 40 | mount |
| 41 | mount |
| 42 | upper side |
| 43 | shoulder |
| 44 | ring element |

1. A gearwheel arrangement (1) comprising a first component (3) and a second component (4), the first component (3) comprising a toothing (6), the second component (4) being arranged at least partly inside the first component (3), and wherein between the first component (3) and the second component (4) at least one elastically deformable element (5) is arranged, wherein the at least one elastically deformable element (5) on elastic deformation in circumferential direction (19) opposes a different resistance than in radial direction.

2. The gearwheel arrangement (1) as claimed in claim 1, wherein the elastically deformable element (5) on elastic deformation in circumferential direction (19) and clockwise opposes a different resistance than elastic deformation in circumferential direction (19) and counter-clockwise.

3. The gearwheel arrangement (1) as claimed in claim 1, wherein the first component (3) comprises first projections (8) projecting underneath the toothing (6) in axial direction (7), between which gaps (17) are formed, wherein also the second component (4) comprises second projections (18) projecting in axial direction (7), which engage in the gaps (17) between the first projections (8) of the first component (3) and wherein the at least one elastically deformable element (5) engages at least partly between the first projections (8) of the first component (3) and the second projections (18) of the second component (4) and comprises first exemptions (35) in the region of engagement.

4. The gearwheel arrangement (1) as claimed in claim 3, wherein the first exemptions (35) are designed in the form of breakthroughs.

5. The gearwheel arrangement (1) as claimed in claim 1, wherein the first component (3) and/or the second component (4) comprises or comprise second exemptions (36) in the area of the bearing of the at least one elastically deformable element (5).

6. The gearwheel arrangement (1) as claimed in claim 1, wherein the at least one elastically deformable element (5) is designed as an elastomer ring with deforming elements (22).

7. The gearwheel arrangement (1) as claimed in claim 6, wherein the elastomer ring consists of a single elastomer.

8. The gearwheel arrangement (1) as claimed in claim 1, wherein a plurality of elastically deformable elements (5) are arranged which are designed as small plate-like springs (39), the springs (39) being oriented in radial direction.

9. The gearwheel arrangement (1) as claimed in claim 8, wherein the springs (39) engage in mounts (40) in the first component (3) and in mounts (41) in the second component (4).

10. The gearwheel arrangement (1) as claimed in claim 1, wherein the resistance which the at least one elastically deformable element resistance which the at least one elastically deformable element (5) on elastic deformation opposes in circumferential direction (19) is smaller than the resistance which the at least one elastically deformable element (5) on an elastic deformation opposes in radial direction.

11. The gearwheel arrangement (1) as claimed in claim 1, wherein the second component (3) is guided with an end face surface on the first component (3).
